(19) United States
(12) Patent Application Publication
(10) Pub. No.: US 2005/0041084 A1
(43) Pub. Date: Feb. 24, 2005

(54) Quick drying, waterfast inkjet recording media

(76) Inventors: Deba Mukherjee, Spring Grove, PA (US); Rich Y. Ryu, Chillicothe, OH (US); Jeffrey E. Gleim, Wellsville, PA (US); Leo M. Nelli, Plainsboro, NJ (US); Timothy R. Hess, Dallastown, PA (US); Ann L. Rishel, York, PA (US); Donald E. Golden, Spring Grove, PA (US)

Correspondence Address: REED SMITH LLP, 2500 ONE LIBERTY PLACE, 1650 MARKET STREET, PHILADELPHIA, PA, 19103, US

(21) Appl. No.: 10/770,753

(22) Filed: Feb. 3, 2004

Related U.S. Application Data
(60) Provisional application No. 60/444,498, filed on Feb. 3, 2003.

(51) Int. Cl. B41J 2/01

(52) U.S. Cl. 347/105; 347/101

(57) ABSTRACT

This patent describes an inkjet printable recording media that dries quickly to produce a waterfast, water-resistant and smudge-resistant print. The media is especially well-suited for the growing field of digital photography where a durable photo-like print is desired, and for high-speed commercial inkjet printing. The invention provides novel coatings, coated media, and methods of use. In particular, the coatings comprise a porous, water-absorbent base coating, a water-resistant ink-receptive coating comprised of nanoparticle-sized pigments, and, optionally, a glossy top coating. The novel coated media comprises an inkjet printable substrate having multiple coating layers, and provides high quality, waterfast images. When used on an inkjet printer, the coated media permits the ink to dry almost instantly to produce a waterfast, high gloss image.

### BACKGROUND OF THE INVENTION

1. Field of the Invention

The present invention relates to recording media, including coated paper and other printable substrates (collectively hereinafter referred to as “paper” or “papers”). The invention also relates to paper coating compositions and methods. More particularly, the present invention relates to papers and paper coatings which produce quick-drying and waterfast images when used in inkjet printers.

2. Background Art

Many types of inkjet recording media are currently available. Available media range in surface gloss from matte to high gloss finishes, have surface textures ranging from smooth to highly textures, and are comprised of substrates including printable transparent films, papers, fabrics, and other known substrates. Some are low-cost uncoated papers for common everyday use, while others are heavily coated for glossy high-resolution photographic reproduction.

There is a growing demand for quick-drying, waterfast glossy papers suitable for printing of digital photography, and also for high-speed commercial ink-jet printing. In particular, the rapid growth in the field of digital photography is creating a demand for glossy inkjet photo papers for the home market. These papers must be fast drying to avoid set-off onto the back of subsequent prints in the printer output stack, and must also be waterfast to resist damage if accidentally wetted. Also, the surface of printed digital photographs must not become tacky at high humidity, or else stacks of photos may block together. Consumers desire an inkjet product that closely emulates the print quality, longevity and durability of conventional photographs, at an affordable price. The glossy inkjet papers and films available today tend to dry slowly, and are not waterfast (i.e. images rub off or bleed when the recording media is wetted after printing). Some very expensive inkjet papers are fast drying, but are not waterfast.

The development of very high-speed commercial inkjet printers is also creating a demand for glossy substrates that can be printed quickly in high volumes to compete with offset printing, especially on smaller volume custom print jobs. To be suitable for use in high-speed commercial applications, inkjet recording media must dry nearly instantly to avoid set-off of the printed image onto the back of the sheets that rapidly accumulate in the printer output tray. One application where inkjet printing might compete with offset printing is custom labels for new product test marketing and small business use. Waterfastness is important for these labels because sales can be very adversely affected by poor aesthetics. In addition, UPC bar codes must not be made unreadable if the label gets damp or wet when on the store shelves or in coolers where, for example, moisture can condense on cold bottles. Known inkjet recording media are not suitable for printing of waterfast custom labels.

The glossy papers and other known recording media currently available use one of two technologies to produce a glossy, inkjet-printable surface: water swellable polymers; and cast coatings. Each of these technologies has their drawbacks. Prints on the water-swellable polymer coatings dry very slowly, are tacky when damp, and will wash off or smear when wetted. Cast coatings can produce images that dry quickly and are not tacky at high humidity, but the inkjet images may still be susceptible to bleeding when wetted (i.e. are not waterfast). Moreover, cast coatings obtain their gloss from a slow, specialized process of drying the coatings in contact with a highly polished metal drum (often chrome plated)-thus, papers produced by this technology are very expensive.

### BRIEF SUMMARY OF THE INVENTION

The present invention is a glossy inkjet-printable recording media suitable for printing high quality images on inkjet printers. The present invention, when printed on an inkjet printer, dries almost instantly and is not susceptible to smearing if it should later get wet.

The recording media of the present invention consists of a multi-layer coated substrate which overcomes the shortcomings of the aforementioned ink-jet paper technologies. The present invention provides an inkjet printable recording media that is glossy, prints well, dries very fast, is water resistant, and is economical to allow inkjet printers to compete with offset printing for short-run custom print jobs. Through the proper selection of the substrate, the present invention is suitable for a wide range of applications such as, for example, CD labels, posters, point-of-sale signage, digital photography, customized labels for small business, and labels for short-run test marketing of new products.

The current invention provides a novel water-resistant ink-receptive coating comprised of nanoparticle-sized pigments (or “nanopigments”) along with cheaper conventional pigments to produce a multi-layered recording media with high gloss, quick dry times and image waterfastness at reasonable/low cost. Gloss is a result of the extreme flatness of the surface of recording media. Coatings utilizing nanopigments are glossy due to both the pigments and the voids between them being smaller than a wavelength of visible light. As a result, they do not scatter light, and therefore appear as clear glossy coatings. Use of nanopigments such as cationic alumina or alumina-treated silica results in coatings in which inkjet dyes are strongly absorbed and thus are resistant to bleeding when wetted. With the proper selection of binders in the coatings, these nanopigments result in a waterfast glossy coating.

The recording media of the present invention provides multiple layers of coatings on a substrate. The first layer is comprised of a porous, water-absorptive base coating which serves to both level the substrate and provide for additional water absorption so that inkjet prints dry quickly. The base coating is applied in sufficient quantity to level the paper and completely cover all the fibers of the substrate. As further described herein, the base coating is comprised of: a blend of conventional coating pigments such as clay, calcined clay, and ground and precipitated calcium carbonates; high surface area fine pigments such as fumed, precipitated or colloidal silica; and one or more binders. The blend of pigments in the base coating is selected to provide a very open, fine pore structure which will draw in water from inks applied to the overlying coating layer(s). The binder or binders used in the base coating layer are added in sufficient quantity to provide good wet strength to the coating, while still producing a porous, open coating.

A second coating layer is applied over the base coating layer. The second coating layer is comprised of a water-resistant, ink-receptive coating. As further described herein, the ink-receptive coating is preferably comprised of a blend of nanopigments such as cationic alumina or alumina-treated silica, and other fine particle-sized pigments such as aluminum trihydrate. A water-resistant binder is also provided. The function of the nanopigments is to bond strongly to the inkjet dyes to make a printed image waterfast (i.e. to prevent ink from bleeding if the paper is re-wetted). The other fine particle-sized pigments aid in maintaining an open structure, and may also reduce product material cost, since they are less expensive on a $/dry pound basis than the nanoparticle sized pigments. Plastic pigment glossing aids can also be added to aid in gloss development if the coating will be supercalendered. In any embodiment of the ink-receptive coating layer, a water-resistant binder is only added in sufficient quantity to make the coating and images waterfast (i.e. to prevent the coating from being damaged when re-wetted and rubbed). The addition of an excessive amount of binder will close up the pore structure and slow the dry times, while the addition of an insufficient amount of binder will allow the coating to rub off when wetted.

After the ink receptive layer is applied, the paper is typically supercalendered. Light supercalendering greatly improves the gloss while maintaining an open, porous structure that dries fast when inkjet printed. As an alternative to supercalendering, a third coating can be applied over the ink-receptive layer to produce a glossy finish. As further described herein, the optional third coating layer consists almost entirely of nanopigment, with a minimum of binder added for water resistance. The gloss coating layer is very thin so as to not close up the porosity of the paper and slow the dry time.

### BRIEF DESCRIPTION OF THE SEVERAL VIEWS OF THE DRAWINGS

The various features of the present invention and its presently preferred embodiments will now be described in greater detail with reference to the drawings.

FIG. 1 is a cross-sectional view of a first single-sided embodiment of the recording media of the present invention having a substrate, a base coat, and an ink-receptive coating.

FIG. 2 is a cross-sectional view of a second single-sided embodiment of the recording media of the present invention having a substrate, a base coat, and an ink-receptive coating.

FIG. 3 is a cross-sectional view of a third single-sided embodiment of the recording media of the present invention having a substrate, a base coat, an ink-receptive coating, and an optional gloss coating.

FIG. 4 is a cross-sectional view of a first double-sided embodiment of the recording media of the present invention having a substrate, a base coat and an ink-receptive coating on each side of the substrate.

FIG. 5 is a cross-sectional view of a second double-sided embodiment of the recording media of the present invention having a substrate, a base coat, an ink-receptive coating, and an optional gloss coating on each side of the substrate.

### DETAILED DESCRIPTION OF THE INVENTION

The present invention is comprised of: a substrate; a porous; a water-absorptive base coating; a water-resistant ink-receptive layer; and, optionally, a glossy top coat. Both single-sided and double sided coated embodiments are within the scope of the present invention.

The substrate may be any substrate known in the paper arts, including but not limited to plant pulp papers, specialty papers, polyester films, polyamides, polystyrene, polyolefins, nonwoven and woven textiles, and any other known coatable substrate. The substrate may be of any known caliper and weight. In a preferred embodiment, the substrate is comprised of a paper base comprising of a blend of hardwood and softwood fibers, and additionally comprises the following ingredients in the following amounts, with all percentages calculated on a dry weight basis.

| | Broad Range | Preferred Range |
|---|---|---|
| Inorganic fillers: | about 0%-35% | about 10%-20% |
| Surface Size: | about 0%-20% | about 2%-10% |
| Retention/Formation aids: | about 0%-10% | about 2%-5% |
| Other Additives: | about 0%-20% | as needed |

Inorganic fillers may be any known in the art. Similarly, the surface size may be comprised of any known sizing agent, such as, but not limited to, starch, polyvinyl alcohol, synthetic polymers or lattices. Retention and formation aids may include any known in the art. Sizing agents may be applied to the wet pulp prior to forming the sheet, or after the sheet has been formed, and may be additionally comprised of alkenyl succinic anhydride (ASA), alkyl ketene dimer (AKD), or urethanes such as Graphsize®. Other additives my be comprised of dyes, optical brighteners, defoamers, and other additives known to those skilled in the art of paper manufacture or the manufacture of other common coating substrates.

The porous, water-absorptive base coating may be comprised of a blend of conventional coating pigments known in the art. In a preferred embodiment, the base coating is comprised of a blend of conventional coating pigments, along with a high surface area fine pigment such as fumed, precipitated, or colloidal silica. Preferably, the base coating is comprised of: inorganic pigments (60%-95%) including, but not limited to, clay, calcined clay, ground or precipitated calcium carbonate, titanium dioxide, and aluminum trihydrate; a fine particle-size, high surface area inorganic pigment (about 0%-30%) including, but not limited to fumed, precipitated, or colloidal silicas or aluminas; and a binder (about 5%-30%) including, but not limited to, Styrene-Butadiene Resin (“SBR”), latex, vinyl acetate latex, starch, or polyvinyl alcohol, or other binders. Additionally, humectants, surfactants, dye fixatives, dyes, optical brighteners, defoamers, lubricants, crosslinkers, dispersants, viscosity modifiers, pH adjusters, defoamers, and other additives commonly known to those skilled in the art of coated paper manufacture may also be included.

The base coating can be applied to the substrate using any known coating device, for example, a blade coater, air knife coater, rod coater, gravure coater, or other devices commonly known to persons skilled in the art. The weight range for the base coating is about 4-30 grams per square meter (gsm) and is preferably from about 8 to about 15 gsm. Once applied, the coating can be dried by conventional means such as drum dryers, forced air dryers, gas & electric IR dryers and other devices commonly known to persons skilled in the art. The moisture content of the coated substrate should be in the range of about 2-8% and most preferable in the range of about 4-6% moisture.

The water-resistant, ink-receptive coating is applied over the base coating, and may be comprised of a mixture of nanopigments, fine particle pigments, binders and coating additives. In a preferred embodiment, the ink-receptive coating is comprised of: a nanopigment (about 40%-90%); a fine particle-sized aluminum trihydrate (about 0%-20%); a cationic latex binder (about 10%-40%); a humectant such as glycerol or polyethylene glycol (“PEG”) (about 0%-15%); and a water soluble surfactant to aid in rewetting when printed such as nonyl-phenol ethoxylate (about 0%-4%). Preferably, the nanopigment is cationic alumina or alumina-treated silica. Optical brighteners, defoamers, pH adjusters, dye fixatives, dyes, lubricants, crosslinkers, dispersants, viscosity modifiers, and other additives known to those skilled in the art may also be included.

In an alternative embodiment, the ingredients of the ink-receptive coating may be varied to produce an easier glossing, cationic ink-receptive coating layer comprised of: a nanopigment (about 40%-90%); a fine particle-sized aluminum trihydrate (about 0%-20%); a cationic latex binder (about 10%-40%); a glossing aid such as a high T_{g} (“glass transition temperature”) latex dispersion or plastic pigment (about 5%-15%); a humectant such as glycerol or PEG (about 0%-15%); a water soluble surfactant to aid in rewetting when printed such as nonyl-phenol ethoxylate (about 0%-4%). Preferably, the nanopigment is cationic alumina or alumina-treated silica, and the embodiment the glossing aid T_{g} is at least 35° Celsius, and is preferably above 60° Celsius. Optical brighteners, defoamers, pH adjusters, dye fixatives, dyes, lubricants, crosslinkers, dispersants, viscosity modifiers, and other additives known to those skilled in the art may also be included.

In another preferred embodiment, the coating utilizes the same ingredients as the first preferred embodiment, with those ingredients reduced proportionally to adjust for the addition of the glossing aid.

In another embodiment of the ink-receptive coating, the ink-receptive coating produces a matte finish. By way of example, Formulation #3 herein exemplifies a matte ink-receptive coating suitable for Ink Jet printing applications. In another example, the ink-receptive coating exemplified by Formulation #1 can be converted to a matte version by utilizing the same ingredients as the first preferred embodiment, with those ingredients reduced proportionally on a dry weight basis to adjust for the addition of the matting agent. In a preferred embodiment, the matting agent is preferably an amorphous silica with a average particle size of about 1-15 microns and a surface area ranging from about 20-600 square meters per gram. On a dry weight basis, the matting agent can be added on a dry-weight basis of about 1%-15% depending on the gloss level desired. Other suitable known matting agents include, but are not limited to, aluminum silicates, aluminum treated silicas, sodium magnesium aluminosilicates and the like. Optical brighteners, defoamers, pH adjusters, dye fixatives, dyes, lubricants, crosslinkers, dispersants, viscosity modifiers, and other additives known to those skilled in the art may also be included.

Each component of the ink-receptive coatings described herein, as well as the final ink-receptive coating, can be made using conventional equipment and methods. For example, a pigment slurry can be made to disperse pigments for use in the coatings by mixing water and pigment in a suitable vessel using known equipment such as a high shear mixer, including but not limited to a Kady Mill or a Cowles disperser. A separate binder mixture can be made by combining (in a separate vessel from the pigment slurry) the binder, humectant, defoamer and water, and then agitating using standard mixing equipment such as a Lightnin' mixer with impellers. To make the final coating, the dispersed pigment slurry is added to the binder mixture using standard mixing equipment. Additives such as dyes, optical brighteners, surfactants, glossing aids, pH adjusters, etc. are then added, preferably in the order listed. Additional water can be added to make adjustments to the coating solids and viscosity to optimize performance and to ensure compatibility with the coating equipment and methods selected.

The ink-receptive coating can be applied to the substrate using a conventional coating device, for example, a blade coater, air knife coater, rod coater, gravure coater, slot die coater and other devices commonly known to persons skilled in the art. The weight of the ink-receptive coating is about 6-30 grams per square meter (gsm), and preferably about 8 to 15 gsm. The coating can be dried by conventional means such as drum dryers, forced air dryers, gas & electric IR dryers and other devices commonly known to persons skilled in the art. The moisture content of the coated substrate should be in the range of about 2-8%, and is preferably in the range of about 4-6% moisture.

Optionally, a third, glossy top coating is applied over the ink-receptive coating layer. The glossy top coating is generally comprised of nanopigments and binders. In a preferred embodiment, a gloss coating is provided comprised of: a nanopigment (about 10-200 nm) having a narrow particle size range and a spherical or near spherical shape (about 75%-90%); a very small particle-sized (about 50 nm) cationic latex binder (about 10%-20%); a humectant such as glycerol or PEG (about 0%-5%); and a water soluble surfactant to aid in rewetting when printed (about 0%-1%). Preferably, the nanopigment is cationic alumina or alumina-treated silica. Optical brighteners, defoamers, pH adjusters, dye fixatives, dyes, lubricants, crosslinkers, dispersants, viscosity modifiers, and other additives known to those skilled in the art may also be included.

In an alternative preferred embodiment, the glossy top coating is comprised of: a nanoparticle (about 10-200 nm) high T_{g}, non-film forming, polymer dispersion (about 70%-90%); a binder, such as, for example, a small particle-sized latex (about 50 nm) or an aqueous solution polymer which dries/cures to a water insoluble state (about 5%-30%); a humectant such as glycerol or PEG (about 0%-5%); and a water soluble surfactant to aid in rewetting when printed (about 0%-1%). Optical brighteners, defoamers, pH adjusters, dye fixatives, dyes, lubricants, crosslinkers, dispersants, viscosity modifiers, and other additives known to those skilled in the art may also be included.

The gloss level can be adjusted by altering the dry weight of the glossy top coating applied on top of the ink-receptive layer. The weight of glossy top coating is about 0.5-7 grams per square meter (gsm) and preferably 2 to 4 gsm. To achieve the higher range of gloss values requires applying the top coat at the high range of coat weights. Lower coating weights allow lower gloss values. Additionally, a suitable matting agent, including but not limited to, larger size particles ranging from about 0.5 microns to greater than about 15 microns such as silicas, alumina-treated silicas, sodium magnesium aluminosilicates and the like can be added to control gloss.

The glossy top coating can be made using the same equipment and methods previously described for manufacture of the ink-receptive coating. For example, in a suitable vessel, water is mixed with the other ingredients using known mixing equipment such as a Lightnin' mixer with impellers.

The glossy top coating can be applied to the substrate using any known coating device such as, for example, a blade coater, air knife coater, rod coater, gravure coater, slot die coater, and other devices commonly known to persons skilled in the art. The weight of glossy top coating is about 0.5-7 grams per square meter (gsm) and preferably 2 to 4 gsm. The coating can be dried by conventional means such as drum dryers, forced air dryers, gas & electric IR dryers and other devices commonly known to persons skilled in the art. The moisture content of the coated substrate should be in the range of about 2-8% and most preferable in the range of about 4-6% moisture.

### EXAMPLES

The following compositions, articles, and methods are exemplary of the present invention. The exemplary embodiments are to be considered in all respects only as illustrative and not restrictive. Additional embodiments of the present invention comprise any combination of the base coating, ink-receptive coating, or glossy top coats to produce a substrate having multiple layers on either or both sides, yielding quick drying, waterfast ink-jet recording media.

| | | |
|---|---|---|
| Material | % Dry Weight | Description |

Formulation #1 - Cationic Nanoparticle Ink Receptive Coating

| | | |
|---|---|---|
| PVP/VA Copolymer W635 | 15.15% | Binder |
| Glycerin | 5.71% | Humectant |
| BYK 032 (defoamer) | 1.14% | Defoamer |
| Catapal 200 Alumina | 60.58% | Pigment |
| Sylojet 710C | 15.14% | Pigment |
| Optiblanc KLN (optical brightener) | 1.56% | Optical Brightener |
| Triton X-100 (surfactant) | 0.72% | Surfactant |

Formulation #2 - Cationic Nanoparticle Ink Receptive Coating

| | | |
|---|---|---|
| PVP/VA Copolymer W635 | 14.6% | Binder |
| Glycerin | 5.5% | Humectant |
| BYK 032 (defoamer) | 1.1% | Defoamer |
| Catapal 200 Alumina | 58.4% | Pigment |
| Sylojet 710C | 14.6% | Pigment |
| Optiblanc KLN (optical brightener) | 1.5% | Optical Brightener |
| Triton X-100 (surfactant) | 0.7% | Surfactant |
| H1Q055 (Styrene-Acrylate | 3.6% | Glossing Aid |
| glossing aid) | | |

Formulation #3 - Matte Ink Receptive Coating

| | | |
|---|---|---|
| Jetsil SK30 silica | 79.0% | Pigment |
| Acronal PR 8689 Acrylate binder | 15.8% | Binder |
| Catiofast CS fixing agent | 1.2% | Dye Fixative |
| Polyvinyl Pyrrolidon | 2.0% | Binder |
| Acrosol C50L Retention Agent | 1.2% | Retention Aid |
| Optical Brightener | 0.8% | Optical Brightener |

Formulation #4 - Water-absorbent, Leveling Base Coating

| | | |
|---|---|---|
| Ground CaCO₃ | 71.7% | Pigment |
| Calcined Clay | 8.0% | Pigment |
| Precipitated Silicone Dioxide | 8.0% | Pigment |
| SBR Latex | 10.4% | Binder |
| Defoamer | 0.10% | Defoamer |
| Calcium Stearate | 0.55% | Lubricant |
| Alcogum viscosity modifier | 0.25% | Viscosity Modifier |
| Ammonia | 0.82% | pH adjuster |
| Dispersant | 0.09% | Dispersant |
| Hexaphos | 0.09% | Pigment dispersant |

Formulation #5 - Glossy Top Coating

| | | |
|---|---|---|
| High T_{g} cationic polymer | 75% | Binder |
| dispersion | | |
| 50 nm particle size cationic latex | 20% | Binder |
| Nitric Acid | 5% | pH Adjuster |

Formulation #6 - Glossy Top Coating

| | | |
|---|---|---|
| Cartacoat 30 H 50 Silica | 95% | Pigment |
| Solution Acrylic polymer H1E015 | 5% | Binder |

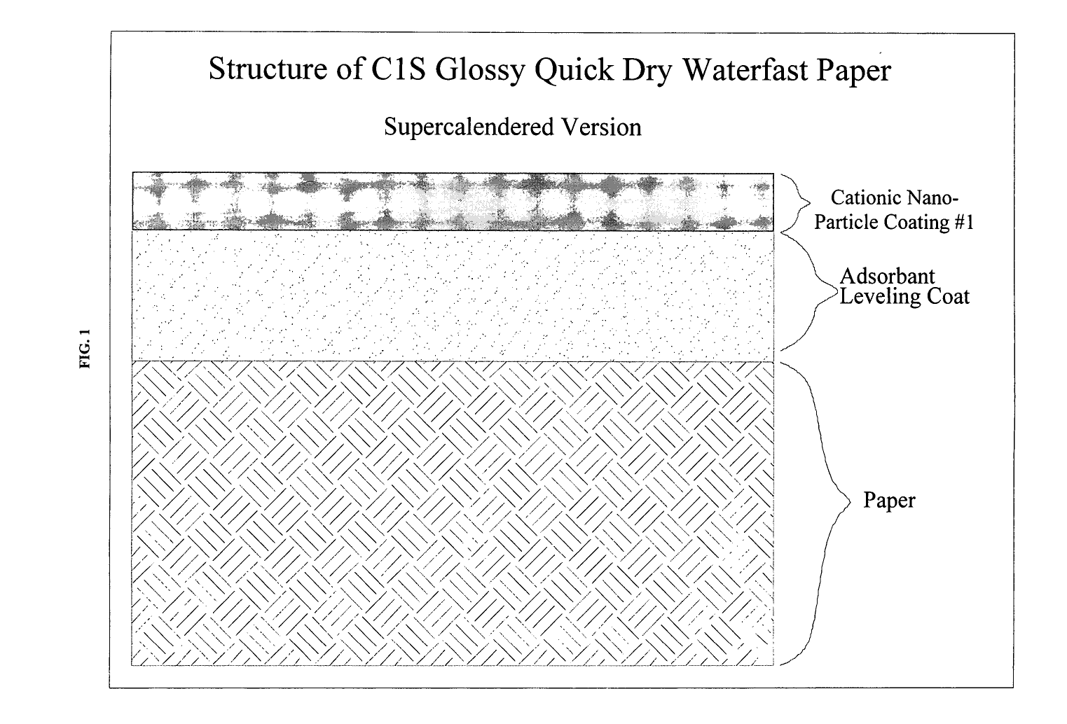

As shown in FIG. 1, a glossy, quick-drying, waterfast, inkjet-printable media is provided having coating on one side only. In this embodiment, one side of the substrate is coated with the absorbent base coating at a rate of about 4-30 g/m², followed by application of the cationic ink-receptive coating (Formulation #1) at the rate of about 6-30 g/m², followed by supercalendering or other finishing process such as calendering, brush calendering, or other known mechanical means to increase gloss. The other finishing process is via application of a glossy top coat as earlier later in this application to produce a 60° gloss of about 30-90%.

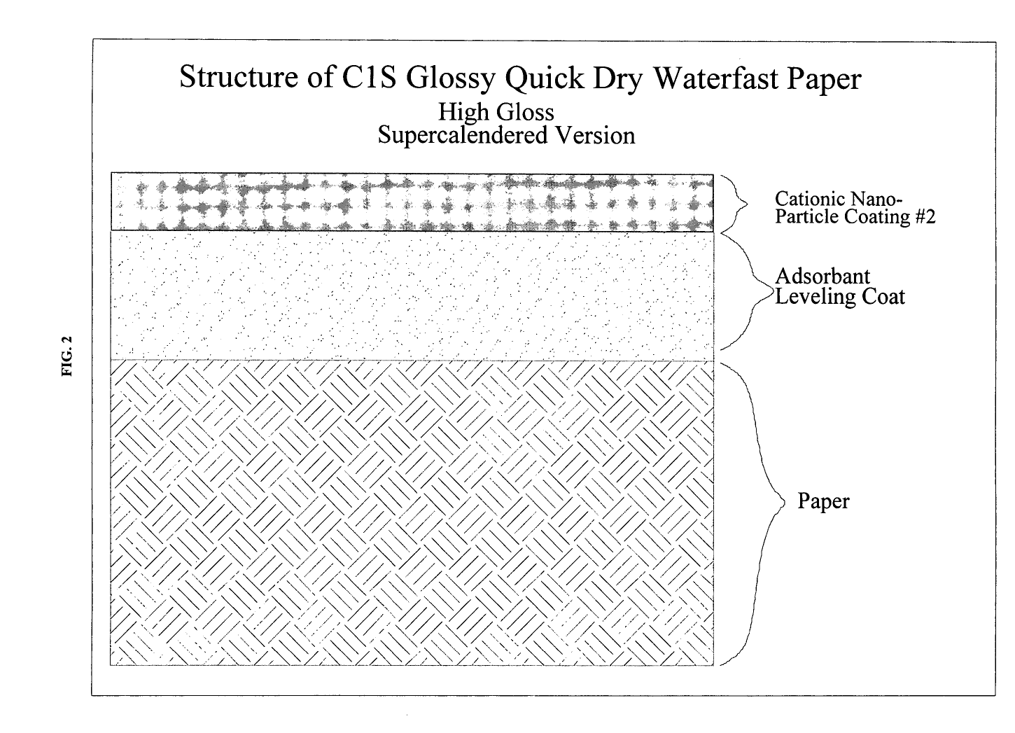

As shown in FIG. 2, a glossy, quick-drying, waterfast, inkjet-printable media is provided having coating on one side only. In this embodiment, one side of the substrate is coated with the absorbent base coating at a rate of about 4-30 g/m², followed by application of the easier-glossing, cationic ink-receptive coating (Formulation #2) at a rate of about 6-30 g/m², followed by supercalendering or other finishing process to produce a 60° gloss of about 30-90%.

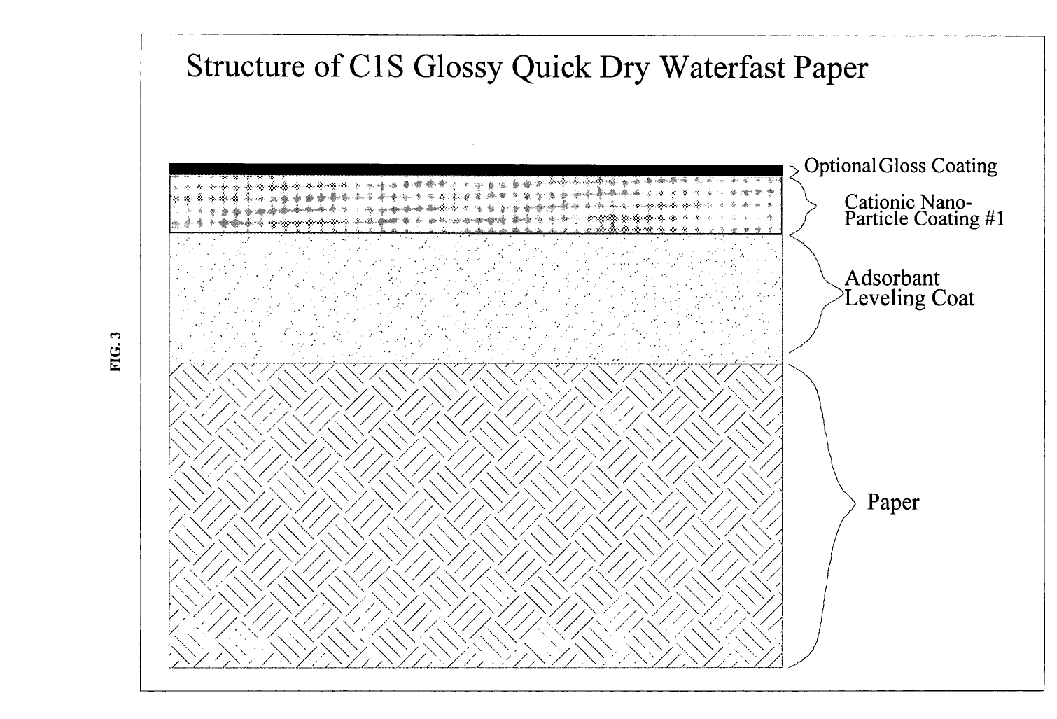

As shown in FIG. 3-a glossy, quick-drying, waterfast, inkjet-printable media is provided having three layers of coating on one side only. The first layer of coating is made by application of the absorbent base coating applied at the rate 4-30 g/m². The second layer of coating is made by application of the cationic ink-receptive coating (Formulation #1) applied at the rate of about 6-30 g/m². The third coating layer is made by application of the cationic gloss coating (Formulation #5 or Formulation #6) applied at the rate of about 0.5-7 g/m² The resulting recording media does not require supercalendering, and provides a finished 60° gloss of about 30-90%.

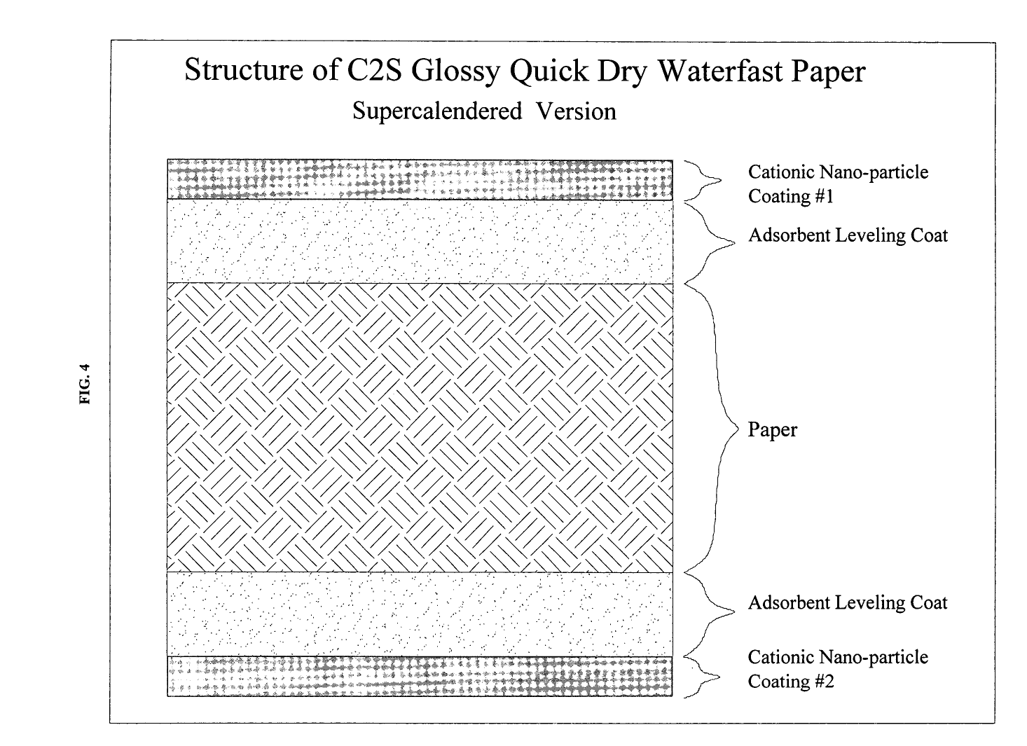

As shown in FIG. 4, a glossy, quick-drying, waterfast, inkjet-printable media is provided having coating on both sides consisting of two layers of coatings per side. The first coating layer on each side is made by application of the absorbent base coating at the rate of about 4-30 g/m². The second coating layer on one side is made by application of the cationic ink-receptive coating (Formulation #1) at the rate of about 6-30 g/m². The second coating on the opposite side is made by application of the easier-glossing, cationic ink-receptive coating (Formulation #2) at the rate of about 6-30 g/m². The resulting recording media is then supercalendered in a conventional supercalender stack with the easier-glossing side against the soft rolls. The finished media has a 60° gloss of about 30-90% on both sides.

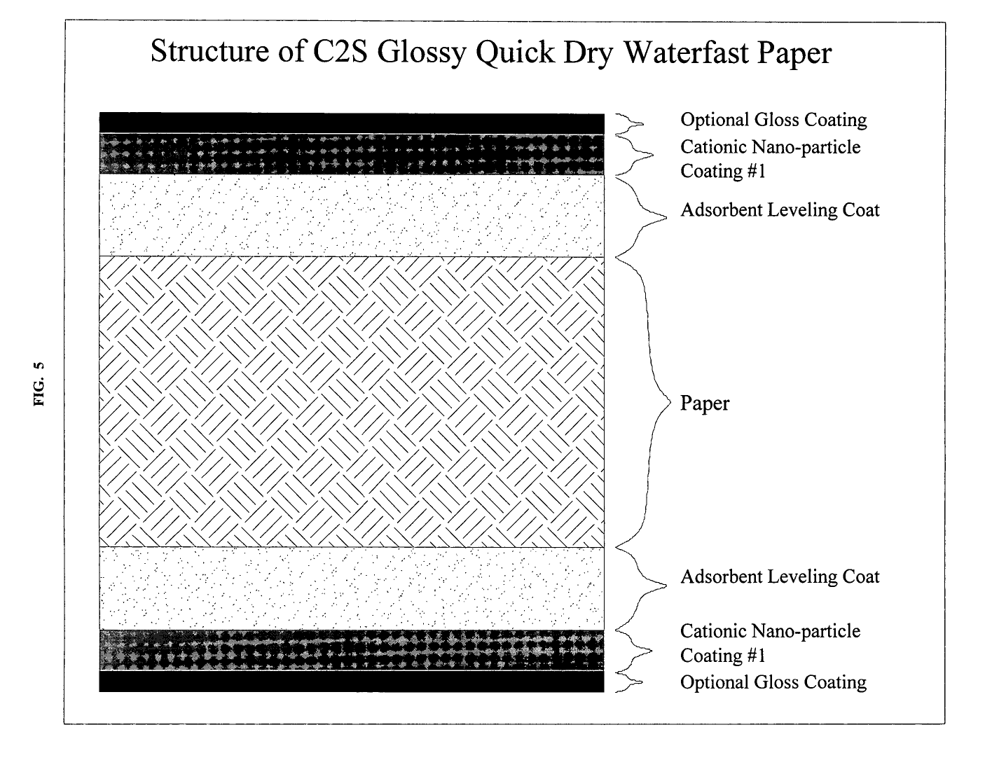

As shown in FIG. 5, a double-sided, glossy, quick-drying, waterfast, inkjet-printable media is provided having three layers of coating on each side. The first layer of coating on each side is made by application of the absorbent base coating at the rate of about 4-30 g/m². The second layer of coating on each side is made by application of the cationic ink-receptive coating (Formulation #1) applied at the rate of about 6-30 g/m². The third coating layer on each side is next made by application of the cationic gloss coating (Formulation #5 or Formulation #6) applied at the rate of about 0.5-7 g/m². The resulting media does not require supercalendering, and provides a finished 60° gloss of about 30-90%.

Another double-sided, quick-drying, waterfast inkjet-printable recording media is provided having one side glossy and the opposite side matte. The first coating layer on the glossy side is made by application of the absorbent base coating at the rate of about 4-30 g/m². The second coating layer on the glossy side is made by application of the easier glossing cationic ink-receptive coating (Formulation #2) at the rate of about 6-30 g/m². The coating applied to the opposite side of the substrate is a matte inkjet coating (Formulation #3) applied at 4-18 g/m². The resulting coated recording media is supercalendered in a conventional supercalender stack with the glossing side against the steel rolls. The finished media has a 60° gloss of about 30-90% on one side, with the opposite side having a matte finish.

Additionally, a double-sided, quick-drying, waterfast, inkjet-printable media is provided having two layers of coating on one side and one layer of matte inkjet coating on the opposite side to provide a matte finish. The first coating layer on the glossy side is made by application of the absorbent base coating at the rate of about 4-30 g/m². The second coating layer on the glossy side is made by application of the cationic ink-receptive coating (Formulation #1) at the rate of about 6-30 g/m². The opposite side of the substrate is coated with the matte inkjet coating (Formulation #3) applied at the rate of about 4-18 g/m². The resulting recording media is supercalendered in a conventional supercalender stack with the glossing side against the steel rolls. The finished media has a 60° gloss of about 30-90% on the glossy side, with the opposite side having a matte finish.

Additionally, a double-sided, quick-drying, waterfast, inkjet-printable media is provided having three layers of coating on one side to produce a glossy finish and one layer of a matte inkjet coating on the opposite side to provide a matte finish. The first layer of coating, on the glossy side, is made by application of the absorbent base coating applied at the rate of about 4-30 g/m². The second layer of coating on the glossy side is made by application of the cationic ink-receptive coating (Formulation #1) applied at the rate of about 6-30 g/m². The third coating layer on the glossy side is made by application of the cationic gloss coating (Formulation #5 or Formulation #6) applied at the rate of about 0.5-7 g/m². The opposite side of the substrate is coated with a single layer of a matte inkjet coating (Formulation #3) applied at the rate of about 4-18 g/m². The resulting recording media does not require supercalendering, and produces a finished 60° gloss of about 30-90% on the glossy side, and a matte finish on the opposite side.

If not otherwise stated herein, it may be assumed that all components and/or processes described heretofore may, if appropriate, be considered to be interchangeable with similar components and/or processes disclosed elsewhere in the specification, unless an express indication is made to the contrary.

It should also be appreciated that the articles, compositions, and methods of the present invention may be configured and conducted as appropriate to suit any context at hand. The embodiments described above are to be considered in all respects only as illustrative and not restrictive. All changes which come within the meaning and range of equivalency of the claims are to be embraced within their scope.

1. A quick drying waterfast inkject recording media, comprising:
a substrate;
at least one base coating; and
at least one ink-receptive layer;
wherein the at least one base coating is porous and water-absorbing and wherein the at least one ink-receptive layer contains at least two nanopigments.

2. The quick drying waterfast inkject recording media of claim 1, wherein the substrate is comprised of cellulose, at least one inorganic filler, at least one sizing agent, and at least one retention/formation aid.

3. The quick drying waterfast inkject recording media of claim 1, wherein the at least one base coating is selected from the group consisting of at least one inorganic pigment, at least one fine inorganic pigment and at least one binder.

4. A quick drying waterfast inkject recording media, comprising:
a substrate;
at least one base coating; and
at least one ink-receptive layer;
wherein the at least one base coating is porous and water-absorbing and wherein the at least one ink-receptive layer contains at least two nanopigments; and
wherein the at least one ink-receptive layer is selected from the group consisting of at least one nanopigment, at least one fine particle pigment, at least one binder, at least one humectant, and at least one surfactant.

5. The quick drying waterfast inkject recording media of claim 4, wherein the at least one nanopigment comprises about 40 to 90 percent of the at least one ink-receptive layer, the at least one fine particle pigment comprises about 0 to 20 percent of the at least one ink-receptive layer, the at least one binder comprises about 10 to 40 percent of the at least one ink-receptive layer, the at least one humectant comprises about 0 to 15 percent of the at least one ink-receptive layer, and the at least one water soluble surfactant comprises about 0 to 4 percent of the at least one ink-receptive layer.

6. The quick drying waterfast inkject recording media of claim 4, wherein the at least one nanopigment is selected from the group consisting of cationic alumina and alumina-treated silica.

7. The quick drying waterfast inkject recording media of claim 4, wherein the at least one fine particle pigment is aluminum trihydrate.

8. The quick drying waterfast inkject recording media of claim 4, wherein the at least one binder is cationic latex.

9. The quick drying waterfast inkject recording media of claim 4, wherein the at least one humectant is selected from the group consisting of glycerol and polyethylene glycol.

10. The quick drying waterfast inkject recording media of claim 4, wherein the at least one water soluble surfactant is nonyl-phenol alumina.

11. A method for producing a quick drying waterfast inkject recording media, comprising the steps of:
providing a substrate;
applying at least one base coating; and
applying at least one ink-receptive layer,
wherein the at least one base coating is porous and water-absorbing and wherein the at least one ink-receptive layer contains at least two nanopigments.
